(19) United States
(12) Patent Application Publication
(10) Pub. No.: US 2010/0087602 A1
(43) Pub. Date: Apr. 8, 2010

(54) Long chain branched polypropylene for cast film applications

(75) Inventors: Fengkui Li, Houston, TX (US); Ryan L. Albores, Pearland, TX (US); John Bieser, Houston, TX (US)

Correspondence Address: FINA TECHNOLOGY INC, PO BOX 674412, HOUSTON, TX, 77267-4412, US

(73) Assignee: FINA TECHNOLOGY, INC., Houston, TX (US)

(21) Appl. No.: 12/247,756

(22) Filed: Oct. 8, 2008

(51) Int. Cl. C08F 10/06; B29C 47/36; B29C 47/78

(52) U.S. Cl. 525/333.7; 264/211.24; 264/464

(57) ABSTRACT

A method comprising contacting a polypropylene, an acrylate-containing compound, and an initiator to form a composition, and reactive extruding the composition to form a polymer blend. A method comprising contacting a polypropylene, a multi-functional acrylate monomer, and an initiator to form a composition, reactive extruding the composition to form a reactive extruded composition, and forming the reactive extruded composition into a film wherein the reactive extruded composition has a melt flow rate that is reduced by equal to or greater than 5% when compared to neat polypropylene.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

1. Technical Field

This disclosure relates to polymeric compositions. More specifically, this disclosure relates to acrylate-containing polypropylene compositions and methods of making and using same.

2. Background

Synthetic polymeric materials, particularly polypropylene resins, are widely used in the manufacturing of a variety of end-use articles ranging from medical devices to food containers. Many industries, such as the packaging industry, utilize these polypropylene materials in various manufacturing processes to create a variety of finished goods including cast and blown films.

Within the polymeric films industry, there are a number of unique applications that ideally require polymers with low melt flow rate. Manufacturers continue to develop polymer compositions with low melt flow rate, which could translate into improved manufacturing efficiency as a result of factors such as lower melt pressure, decreased energy consumption and increased line speed. Given the foregoing discussion, it would be desirable to develop polymeric compositions that retain user-desired mechanical and/or physical properties while having an increased ease of processing.

### SUMMARY

Disclosed herein is a method comprising contacting a polypropylene, an acrylate-containing compound, and an initiator to form a composition, and reactive extruding the composition to form a polymer blend.

Also disclosed herein is a method comprising contacting a polypropylene, a multi-functional acrylate monomer, and an initiator to form a composition; reactive extruding the composition to form a reactive extruded composition, and forming the reactive extruded composition into a film wherein the reactive extruded composition has a melt flow rate that is reduced by equal to or greater than 5% when compared to neat polypropylene.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a plot of the DSC recrystallization for the samples from Example 1 during cooling process.

FIG. 2 is a plot of the DSC melting for the samples from Example 1 during heating process.

FIG. 3 is a plot of complex viscosity as a function of frequency for the samples from Example 1.

FIG. 4 is a plot of melt pressure as a function of melt flow rate (MFR) for the samples from Example 4.

FIG. 5 is a plot of extrusion output at 150 rpm as a function of melt flow rate (MFR) for the samples from Example 4.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are acrylate-containing polypropylene compositions (APPCs) and methods of making and using same. In an embodiment, the APPC comprises polypropylene, an acrylate-containing compound, and one or more initiators. The resulting APPC may display a variety of improved properties, for example reduced melt flow rate (MFR), when compared to an otherwise similar polypropylene composition lacking the acrylate-containing compound.

In an embodiment, the APPC comprises polypropylene. The polypropylene may be a homopolymer. Polypropylene homopolymers suitable for use in this disclosure may be readily selected from known types with the aid of this disclosure. For example, the polypropylene homopolymer may be atactic, isotactic, hemi-isotactic, syndiotactic, or combinations thereof. A polymer is “atactic” when its pendant groups are arranged in a random fashion on both sides of the chain of the polymer. In contrast, a polymer is “isotactic” when all of its pendant groups are arranged on the same side of the chain and “syndiotactic” when its pendant groups alternate on opposite sides of the chain. In hemi-isotactic polymer, every other repeat unit has a random substituent.

In an embodiment, a polypropylene homopolymer suitable for use in this disclosure may have a density of from 0.895 g/cc to 0.920 g/cc, alternatively from 0.900 g/cc to 0.915 g/cc, and alternatively from 0.905 g/cc to 0.915 g/cc as determined in accordance with ASTM D-1505; a melting temperature of from 150° C. to 170° C., alternatively from 155° C. to 168° C., and alternatively from 160° C. to 165° C. as determined by differential scanning calorimetry (DSC); a melt flow rate of from 0.5 g/10 min. to 30 g/10 min., alternatively from 1.0 g/10 min. to 15 g/10 min., and alternatively from 1.5 g/10 min. to 5.0 g/10 min. as determined in accordance with ASTM D-1238 condition “L”; a tensile modulus of from 200,000 psi to 350,000 psi; alternatively from 220,000 psi to 320,000 psi, and alternatively from 250,000 psi to 320,000 psi as determined in accordance with ASTM D-638; a tensile stress at yield of from 3,000 psi to 6,000 psi, alternatively from 3,500 psi to 5,500 psi, and alternatively from 4,000 psi to 5,500 psi as determined in accordance with ASTM D-638; a tensile strain at yield of from 5% to 30%, alternatively from 5% to 20%, and alternatively from 5% to 15% as determined in accordance with ASTM D-638; a flexural modulus of from 120,000 psi to 330,000 psi, alternatively from 190,000 psi to 310,000 psi, and alternatively of from 220,000 psi to 300,000 psi as determined in accordance with ASTM D-790; a Gardner impact of from 3 in-lb to 50 in-lb, alternatively from 5 in-lb to 30 in-lb, and alternatively from 9 in-lb to 25 in-lb as determined in accordance with ASTM D-2463; a Notched Izod Impact Strength of from 0.2 ft lb/in to 20 ft lb/in, alternatively from 0.5 ft lb/in to 15 ft lb/in, and alternatively from 0.5 ft lb/in to 10 ft lb/in as determined in accordance with ASTM D-256A; a hardness shore D of from 30 to 90, alternatively from 50 to 85, and alternatively from 60 to 80 as determined in accordance with ASTM D-2240; and a heat distortion temperature of from 50° C. to 125° C., alternatively from 80° C. to 115° C., and alternatively from 90° C. to 110° C. as determined in accordance with ASTM D-648.

Examples of polypropylene homopolymers suitable for use in this disclosure include without limitation 3371, 3271, 3270, 3276, and 3761, which are polypropylene homopolymers commercially available from Total Petrochemicals USA, Inc. In an embodiment, the polypropylene homopolymer (e.g., 3371) has generally the physical properties set forth in Table 1.

TABLE 1

| | 3371 | |
|---|---|---|
| Physical Properties | Typical Value | Test Method |
| Density, g/cc | 0.905 | ASTM D-1505 |
| Melt Flow Rate (MFR), g/10 min. | 2.8 | ASTM D-1238 |
| | | condition “L” |

Mechanical Properties

| | | |
|---|---|---|
| Tensile Modulus, psi | 235,000 | ASTM D-638 |
| Tensile Stress at Yield, psi | 5,100 | ASTM D-638 |
| Tensile Strain at Yield, % | 7.5 | ASTM D-638 |
| Flexural Modulus, psi | 202,000 | ASTM D-790 |

Impact Properties

| | | |
|---|---|---|
| Gardner impact, in-lb | 149.2 | ASTM D-2463 |
| Notched Izod Impact Strength, ft lb/in | 0.69 | ASTM D-256A |

Hardness

| | | |
|---|---|---|
| Hardness Shore D | 75 | ASTM D-2240 |

Thermal Properties

| | | |
|---|---|---|
| Heat distortion temperature, ° F. | 207 | ASTM D-648 |
| Melting Temperature, ° F. | 325 | DSC |

In an embodiment, the polypropylene may be a copolymer such as an impact copolymer. Polypropylene impact copolymers (PPics) are bi-phasic polymers wherein a polypropylene homopolymer phase or component is joined to a copolymer phase or component. PPics show distinct homopolymer phases that are interrupted by short sequences or blocks having a random arrangement of ethylene and propylene. In comparison to random copolymers, the block segments comprising a random copolymer of propylene and ethylene (also referred to as an ethylene/propylene rubber EPR) may have certain polymeric characteristics (e.g., intrinsic viscosity) that differ from that of the copolymer as a whole. In an embodiment, the EPR portion of the PPics comprises greater than 14 wt. % of the PPics, alternatively greater than 18 wt. % of the PPics, alternatively from 14 wt. % to 18 wt. % of the PPics.

The amount of ethylene present in the EPR portion of the PPics may be from 38 wt. % to 50 wt. %, alternatively from 40 wt. % to 45 wt. % based on the total weight of the EPR portion. The amount of ethylene present in the EPR portion of the PPics may be determined spectrophotometrically using a Fourier transform infrared spectroscopy (FTIR) method. Specifically, the FTIR spectrum of a polymeric sample is recorded for a series of samples having a known EPR ethylene content. The ratio of transmittance at 720 cm⁻¹/900 cm⁻¹ is calculated for each ethylene concentration and a calibration curve may then be constructed. Linear regression analysis on the calibration curve can then be carried out to derive an equation that is then used to determine the EPR ethylene content for a sample material.

The EPR portion of the PPics may exhibit an intrinsic viscosity different from that of the propylene homopolymer component. Herein intrinsic viscosity refers to the capability of a polymer in solution to increase the viscosity of said solution. Viscosity is defined herein as the resistance to flow due to internal friction. In an embodiment, the intrinsic viscosity of the EPR portion of the PPics may be greater than 2.0 dl/g, alternatively from 2.0 dl/g to 3.0 dl/g, alternatively from 2.4 dl/g to 3.0 dl/g, alternatively from 2.4 dl/g to 2.7 dl/g, alternatively from 2.6 dl/g to 2.8 dl/g. The intrinsic viscosity of the EPR portion of the PPHC is determined in accordance with ASTM D5225.

In an embodiment, the PPics may have a melt flow rate (MFR) of from 0.5 g/10 min. to 30 g/10 min., alternatively from 1.0 g/10 min. to 15 g/10 min., alternatively from 1.0 g/10 min. to 10.0 g/10 min., alternatively from 1.0 g/10 min. to 5.0 g/10 min., alternatively from 1.0 g/10 min. to 3.0 g/10 min. In an embodiment, the PPics is a reactor grade resin without modification, which may also be termed a low order PP. In some embodiments, the PPics is a controlled rheology grade resin, wherein the melt flow rate has been adjusted by various techniques such as visbreaking. For example, MFR may be increased by visbreaking as described in U.S. Pat. No. 6,503,990, which is incorporated by reference in its entirety. As described in that publication, quantities of peroxide are mixed with polymer resin in flake, powder, or pellet form to increase the MFR of the resin. MFR as defined herein refers to the quantity of a melted polymer resin that will flow through an orifice at a specified temperature and under a specified load. The MFR may be determined using a dead-weight piston Plastometer that extrudes polypropylene through an orifice of specified dimensions at a temperature of 230° C. and a load of 2.16 kg in accordance with ASTM D1238.

A representative example of a suitable PPics includes without limitation 4280W, which is an impact copolymer resin commercially available from Total Petrochemicals USA Inc. In an embodiment, the PPic (e.g., 4280W) has generally the physical properties set forth in Table 2.

TABLE 2

| | | |
|---|---|---|
| Properties | Typical Value | ASTM Method |

Physical

| | | |
|---|---|---|
| Melt Flow, g/10 min. | 1.3 | D1238 |
| Density, g/cc | 0.905 | D1505 |
| Melting Point, ° C. | 160-165 | DSC |

Mechanical

| | | |
|---|---|---|
| Tensile strength at Yield, psi (MPa) | 3600 (25) | D638 |
| Elongation at Yield, % | 7 | D638 |
| Flexural Modulus, psi (MPa) | 190,000 (1,300) | D790 |
| Notched-ft.lb./in. (J/m) | No break | ASTM D256A |

Thermal

| | | |
|---|---|---|
| Heat Deflection, ° C. | 93 | D648 |

In an embodiment, the polypropylene may be a random copolymer, for example a copolymer of propylene with one or more alpha olefin monomers such as ethylene, butene, hexene, etc. In an embodiment, the polypropylene is a random ethylene-propylene (C₂/C₃) copolymer (REPC) and may comprise of from 1 wt. % to 10 wt. % ethylene, alternatively from 3 wt. % to 7 wt. % ethylene alternatively from 3 wt. % to 6 wt. % ethylene, alternatively from 4 wt. % to 6.5 wt. % ethylene, alternatively from 5.5 wt. % to 6.5 wt. % ethylene, alternatively from 5.8 wt. % to 6.2 wt. % ethylene, alternatively 6 wt. % ethylene. The REPC may have a melting point temperature of from 100° C. to 155° C., alternatively from 110° C. to 148° C., alternatively from 115° C. to 121° C. Furthermore, the REPC may have a molecular weight distribution of from 1 to 8, alternatively from 2 to 6, alternatively from 3 to 5. The melting point range is indicative of the degree of crystallinity of the polymer while the molecular weight distribution refers to the relation between the number of molecules in a polymer and their individual chain length.

In ethylene-propylene random copolymers, the ethylene molecules are inserted randomly into the polymer backbone between repeating propylene molecules, hence the term random copolymer. Without wishing to be limited by theory, using a metallocene catalyst to form the REPC may allow for better control of the crystalline structure of the copolymer due to its isotactic tendency to arrange the attaching molecules. The metallocene catalyst may ensure that a majority of the propylene monomer is attached so that the pendant methane groups (—CH₃) line up in an isotactic orientation relative to the backbone of the molecule. The ethylene units do not have a tacticity as they do not have any pendant units, just four hydrogen (H) atoms attached to a carbon backbone (C—C).

In the preparation of an REPC, a certain amount of amorphous polymer is produced. This amorphous or atactic polymer is soluble in xylene and is thus termed the xylene soluble fraction or percent xylene solubles (XS %). In determining XS %, the polymer is dissolved in hot xylene and then the solution cooled to 0° C. which results in the precipitation of the isotactic or crystalline portion of the polymer. The XS % is that portion of the original amount that remained soluble in the cold xylene. Consequently, the XS % in the polymer is further indicative of the extent of crystalline polymer formed. The total amount of polymer (100%) is the sum of the xylene soluble fraction and the xylene insoluble fraction. In an embodiment, the REPC has a xylene soluble fraction of from 0.1% to 6%; alternatively from 0.2% to 2%; and alternatively from 0.3% to 1%, as determined in accordance with ASTM D 5492-98.

In an embodiment, an REPC suitable for use in this disclosure may have a density of from 0.890 g/cc to 0.920 g/cc, alternatively from 0.895 g/cc to 0.915 g/cc, and alternatively from 0.900 g/cc to 0.910 g/cc as determined in accordance with ASTM D-1505. In an embodiment, an mREPC suitable for use in this disclosure may have a melt flow rate of from 0.5 g/10 min. to 2000 g/10 min., alternatively from 1 g/10 min. to 1000 g/10 min., and alternatively from 10 g/10 min. to 500 g/10 min, as determined in accordance with ASTM D-1238 condition “L.” In an embodiment, a film prepared from an REPC suitable for use in this disclosure may have a gloss at 45° of from 70 to 95, alternatively from 75 to 90, and alternatively from 80 to 90 as determined in accordance with ASTM D-2457.

An example of a suitable REPC includes without limitation a metallocene catalyzed ethylene-propylene random copolymer known as EOD 02-15 available from Total Petrochemicals USA, Inc. In an embodiment, the REPC (e.g., EOD 02-15) generally has the physical properties set forth in Table 3.

TABLE 3

| | Typical Value | ASTM Method |
|---|---|---|
| Resin Properties | | |
| Melt Flow, g/10 min. | 11 | D1238 |
| Density, g/cc | 0.895 | D1505 |
| Melting Point, ° F. (° C.) | 246 (119) | DSC |
| Film Properties⁽¹⁾ | | |
| Non-oriented-2 mil (50 μm) | | |
| Haze, % | 0.3 | D1003 |
| Gloss @ 45°, % | 90 | D2457 |
| 1% Secant Modulus (MD), psi (MPa) | 50,000 (345) | D882 |
| Ultimate Tensile Strength (MD), | 5,000 (35) | D882 |
| psi (MPa) | | |
| Ultimate Elongation (MD), % | 700 | D882 |
| Heat Seal Temperature⁽¹⁾, | 221 (105) | |
| ° F. (° C.) | | |

⁽¹⁾Seal condition: die pressure 60 psi (413 kPa), dwell time 1.0 sec

The polypropylene may be prepared using any suitable catalyst known to one of ordinary skill in the art with the aid of this disclosure. For example, the polypropylene may be prepared using a Ziegler-Natta catalyst, metallocene catalyst, or combinations thereof.

In an embodiment, the polypropylene is prepared using Ziegler-Natta catalysts, which are typically based on titanium and organometallic aluminum compounds, for example triethylaluminum (C₂H₅)₃Al. Ziegler-Natta catalysts and processes for forming such catalysts are known in the art and examples of such are described in U.S. Pat. Nos. 4,298,718; 4,544,717; and 4,767,735, each of which is incorporated by reference herein in its entirety.

In another embodiment, the polypropylene may be prepared using a metallocene catalyst. Metallocene catalysts may be characterized generally as coordination compounds incorporating one or more cyclopentadienyl (Cp) groups (which may be substituted or unsubstituted, each substitution being the same or different) coordinated with a transition metal through π bonding. Examples of metallocene catalysts and processes for forming such catalysts are described in U.S. Pat. Nos. 4,794,096 and 4,975,403, each of which is incorporated by reference herein in its entirety. Examples of polypropylenes prepared through the use of metallocene catalysts are described in further detail in U.S. Pat. Nos. 5,158,920; 5,416,228; 5,789,502; 5,807,800; 5,968,864; 6,225,251; 6,777,366; 6,777,367; 6,579,962; 6,468,936; 6,579,962; and 6,432,860, each of which is incorporated by reference herein in its entirety.

The polypropylene may also be prepared using any other catalyst such as a combination of Ziegler-Natta and metallocene catalysts, for example as described in U.S. Pat. Nos. 7,056,991 and 6,653,254, each of which is incorporated by reference herein in its entirety.

The polypropylene may be formed by placing propylene alone in a suitable reaction vessel in the presence of a catalyst (e.g., Ziegler-Natta, metallocene, etc.) and under suitable reaction conditions for polymerization thereof. Standard equipment and processes for polymerizing the propylene into a polymer are known to one skilled in the art. Such processes may include solution phase, gas phase, slurry phase, bulk phase, high pressure processes or combinations thereof. Such processes are described in detail in U.S. Pat. Nos. 5,525,678; 6,420,580; 6,380,328; 6,359,072; 6,346,586; 6,340,730; 6,339,134; 6,300,436; 6,274,684; 6,271,323; 6,248,845; 6,245,868; 6,245,705; 6,242,545; 6,211,105; 6,207,606; 6,180,735; and 6,147,173, which are incorporated herein by reference in their entirety.

In an embodiment, the polypropylene is formed by a gas phase polymerization process. One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig, or from about 250 psig to about 350 psig. The reactor temperature in a gas phase process may vary from about 30° C. to about 120° C., or from about 60° C. to about 115° C., or from about 70° C. to about 110° C., or from about 70° C. to about 95° C., for example U.S. Pat. Nos. 4,543,399; 4,588,790; 5,028,670; 5,317,036; 5,352,749; 5,405,922; 5,436,304; 5,456,471; 5,462,999; 5,616,661; 5,627,242; 5,665,818; 5,677,375; and 5,668,228, which are incorporated herein by reference in their entirety.

In an embodiment, the polypropylene is formed by a slurry phase polymerization process. Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutene). The medium employed is generally liquid under the conditions of polymerization and relatively inert. A bulk phase process is similar to that of a slurry process. However, a process may be a bulk process, a slurry process, or a bulk slurry process.

In an embodiment, the polypropylene is present in the APPC in an amount of from 85 weight percent (wt. %) to 99.9 wt. % by total weight of the APPC, alternatively from 95 wt. % to 99.5 wt. %, alternatively from 98 wt. % to 99.5 wt. %.

In an embodiment, the APPC comprises an acrylate-containing compound. The acrylate-containing compound may be hydrophilic, hydrophobic, or combinations thereof. In an embodiment, the acrylate-containing compound comprises an acrylate monomer, alternatively a multi-functional acrylate monomer. Herein a multi-functional acrylate monomer refers to a monomer having two or more acrylate sites. In the presence of polypropylene and additional components to be described in more detail later herein, the multi-functional acrylate monomer may polymerize to form a polyacrylate. Conditions for the polymerization of the acrylate monomer will be described in more detail later herein. The multi-functional acrylate monomer may include without limitation diacrylates, triacrylates, tetraacrylates, pentaacrylates and the like, or combinations thereof.

In an embodiment, the acrylate-containing compound comprises a diacrylate monomer. Examples of diacrylate monomers suitable for use in this disclosure include without limitation 1,3-butylene glycol diacrylate, 1,4-butanediol diacrylate, 1,6-hexanediol diacrylate, alkoxylated aliphatic diacrylate, alkoxylated cyclohexane dimethanol diacrylate, alkoxylated hexanediol diacrylate, alkoxylated neopentyl glycol diacrylate, cyclohexane dimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, neopentyl glycol diacrylate, polyethylene glycol (200) diacrylate, polyethylene glycol (400) diacrylate, polyethylene glycol (600) diacrylate, propoxylated (2) neopentyl glycol diacrylate, propoxylated neopentyl glycol diacrylate, tetraethylene glycol diacrylate, tricyclodecane dimethanol diacrylate, triethylene glycol diacrylate, tripropylene glycol diacrylate, or combinations thereof.

In an embodiment, the acrylate-containing compound comprises a triacrylate monomer. Examples of triacrylate monomers suitable for use in this disclosure include without limitation ethoxylated (15) trimethylolpropane triacrylate (TMPTA), ethoxylated trimethylolpropane triacrylate, ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate, propoxylated (5.5) glyceryl triacrylate, trimethylolpropane triacrylate, pentaerythritol triacrylate, propoxylated (3) glyceryl triacrylate, propoxylated (3) trimethylolpropane triacrylate, propoxylated (6) trimethylolpropane triacrylate, trimethylolpropane triacrylate, trimethylolpropane trimethacrylate, tris(2-hydroxy ethyl)isocyanurate triacrylate, or combinations thereof.

In an embodiment, the acrylate-containing compound comprises a tetraacrylate monomer, alternatively a pentaacrylate monomer. Examples of tetra and penta acrylate monomers suitable for use in this disclosure include without limitation di-trimethylolpropane tetraacrylate, dipentaerythritol pentaacrylate, ethoxylated (4) pentaerythritol tetraacrylate, dipentaerythritol pentaacrylate, pentaacrylate ester, pentaerythritol tetraacrylate, or combinations thereof.

In an embodiment, the acrylate-containing compound may comprise allyl-acrylate-containing multi-functional monomers or allyl-containing monomers. Examples of allyl acrylate monomers suitable for use in this disclosure include without limitation allyl acrylate, allyl methacrylate, allyl-trans-2,3-dimethylacrylate, trimethylolpropane allyl ether, triallyl cyanurate, triallyl isocyanurate, or combinations thereof.

In an embodiment, the acrylate-containing compound may be present in the APPC in an amount of from 0.1 wt. % to 15 wt. %, alternatively from 0.2 wt. % to 10 wt. %, alternatively from 0.5 wt. % to 10 wt. %, alternatively from 0.5 wt. % to 5 wt. %, alternatively from 0.5 wt. % to 4 wt. %, alternatively from 0.5 wt. % to 3 wt. %, alternatively from 0.5 wt. % to 2 wt. %, and alternatively from 0.5 wt. % to 1.5 wt. %, based on the total weight of the final composition.

In an embodiment, a mixture for the preparation of an APPC comprises an initiator. Any initiator that facilitates the polymerization of the acrylate monomer may be employed. Initiators suitable for use in this disclosure include without limitation benzoyl peroxide, lauroyl peroxide, t-butyl peroxybenzoate, 1,1-di-t-butylperoxy-2,4-di-t-butylcyclohexane, diacyl peroxides, peroxydicarbonates, monoperoxycarbonates, peroxyketals, peroxyesters, dialkyl peroxides, hydroperoxides, or combinations thereof. In an embodiment, the initiator comprises LUPERSOL 101, which is 2,5-dimethyl-2,5-di-(tert-butylperoxy)hexane commercially available from Arkema, alternatively the initiator comprises TRIGANOX 301, which is 3,6,9-triethyl-3,6,9-trimethyl-1,4,7-triperoxonane commercially available from Akzo Nobel.

The selection of initiator and effective amount will depend on numerous factors (e.g., temperature, reaction time) and can be chosen by one skilled in the art with the benefits of this disclosure to meet the needs of the process. Polymerization initiators and their effective amounts have been described in U.S. Pat. Nos. 6,822,046; 4,861,127; 5,559,162; 4,433,099; and 7,179,873, each of which is incorporated by reference herein in its entirety.

In an embodiment, the initiator may be present in a reaction mixture in an amount of from 0.1 wt. % to 15 wt. %, alternatively from 0.2 wt. % to 10 wt. %, alternatively from 0.5 wt. % to 5 wt. %, alternatively from 0.5 wt. % to 4 wt. %, alternatively from 0.5 wt. % to 3 wt. %, alternatively from 0.5 wt. % to 2 wt. %, alternatively from 0.5 wt. % to 1.5 wt. %, based upon the weight of the acrylate in the compound.

In another embodiment, the initiator may be present in a reaction mixture in an amount of from 20 ppm to 5000 ppm, alternatively from 50 ppm to 1000 ppm, alternatively from 100 ppm to 500 ppm, alternatively from 200 ppm to 300 ppm based on the total weight of the final composition.

In an embodiment, the APPC may further comprise one or more additives to impart desired physical properties, such as printability, increased gloss, etc. Examples of such additives include without limitation odorless mineral spirits, stabilizers, ultra-violet screening agents, oxidants, anti-oxidants, anti-static agents, ultraviolet light absorbents, fire retardants, processing oils, mold release agents, coloring agents, pigments/dyes, fillers, blowing agents, fluorescing agent, surfactant, tackifiers, processing oils, and/or other suitable additives. The aforementioned additives may be used either singularly or in combination to form various formulations of the polymer. For example, stabilizers or stabilization agents may be employed to help protect the polymer resin from degradation due to exposure to excessive temperatures and/or ultraviolet light. These additives may be included in amounts effective to impart the desired properties. Effective additive amounts and processes for inclusion of these additives to polymeric compositions may be determined by one skilled in the art with the aid of this disclosure. For example, the additives may be present in an amount of from 0.1 wt. % to 50 wt. %, alternatively from 1 wt. % to 40 wt. %, alternatively from 2 wt. % to 30 wt. % based on the total weight of the composition.

In an embodiment, an APPC may be prepared by contacting a polypropylene, an acrylate-containing compound, and an initiator, each of the type described previously herein, under conditions suitable for the formation of a polymeric blend. For example, the components of the APPC may be subjected to reactive extrusion wherein the components are dry blended, fed into an extruder, and melted inside the extruder. The process may be carried out using a continuous mixer such as for example a mixer consisting of a intermeshing co-rotating twin screw extruder for mixing/melting the components of the APPC and a single screw extruder or a gear pump for pumping. Reaction conditions may be varied as known to one of ordinary skill in the art with the aid of this disclosure. Following reaction extrusion the melt may be used to form an end use article or may be pelletized and used subsequently to form an end use article.

In an embodiment, the resulting APPC may display a reduced melt flow rate (MFR) when compared to neat polypropylene. The MFR may be reduced by from 10% to 60%, alternatively from 20% to 60%, alternatively from 30% to 60% when compared to neat polypropylene. MFR as defined herein refers to the quantity of a melted polymer resin that will flow through an orifice at a specified temperature and under a specified load. The MFR may be determined using a dead-weight piston Plastometer that extrudes polypropylene through an orifice of specified dimensions at a temperature of 230° C. and a load of 2.16 kg in accordance with ASTM Standard Test Method D-1238. In an embodiment, an APPC may have a melt flow rate (MFR) of from 0.5 g/10 min. to 20 g/10 min., alternatively from 0.75 g/10 min. to 10 g/10 min., alternatively from 0.75 g/10 min. to 5 g/10 min. In comparison, neat polypropylene may have an MFR of from 0.75 g/10 min. to 50 g/10 min., alternatively from 0.75 g/10 min. to 25 g/10 min., alternatively from 0.75 g/10 min. to 15 g/10 min.

Without wishing to be limited by theory, the resulting APPC may also display an increased level of long chain branching (LCB) when compared to neat polypropylene. LCB can be indirectly reflected by the increased zero-shear viscosity of the APPC and more shear thinning as compared to the polypropylene base resin.

In an embodiment, the APPC may display improved processability when compared to neat polypropylene with similar melt flow rate. This improved processability may be reflected by a reduction in extrusion melt pressure, extruder torque, energy expenditure, and increases in the extrusion rates for processing of the composition. For example, the APPC may extrude at a reduced melt pressure when compared to neat polypropylene with similar melt flow rate. In an embodiment, the melt pressure is reduced by greater than 10%, alternatively greater than 30%, alternatively greater than 60% when compared to neat polypropylene with similar melt flow rate. Without wishing to be limited by theory, the APPC may display a reduced melt pressure due to the presence of long chain branching. The lower melt pressure of the APPC may result in a higher extrusion rate when compared to neat polypropylene with similar melt flow rate. In an embodiment, the APPC has an extrusion rate that is increased by greater than 5%, alternatively greater than 10%, alternatively greater than 20% when compared to neat polypropylene having a similar melt flow rate.

In an embodiment, the APPC may extrude at a reduced torque when compared to neat polypropylene with similar melt flow rate. The extruder torque is a measure of the resistance the extruder motor experiences as it conveys the composition. In an embodiment, the extruder torque is reduced by greater than 5%, alternatively greater than 10%, alternatively greater than 15% when compared to neat polypropylene with similar melt flow rate.

In an embodiment, the APPC may be extruded at a reduced specific energy when compared to neat polypropylene. The specific energy is an important factor in twin-screw extruder that refers to the amount of energy required to perform extrusion process. In an embodiment, the APPC is extruded at a specific energy lowered by greater than 5%, alternatively greater than 10%, alternatively greater than 15% when compared to neat polypropylene with equivalent melt flow rate.

The APPCs of this disclosure may be converted to end-use articles by any suitable process and used to manufacture extruded articles such as foam, extruded and/or oriented sheets or film, cast film, blown film, extrusion coated film, etc. The use of APPCs of this disclosure in the various processes described may result in an improved manufacturing efficiency due in part to the improvements in a variety of factors (e.g., melt pressure, torque, etc.) resulting in an increase in through-put rates during processing of the APPCs.

In an embodiment, the APPC may be used to prepare a cast film. The APPC pellets or fluff may be heated in an extruder to a temperature of from 180° C. to 350° C., alternatively from 190° C. to 280° C., alternatively from 200° C. to 250° C. The molten plaque may exit through the die and be taken up onto a roller without additional stretching to form an extruded film. Alternatively, the molten plaque may exit through the die and be uniaxially stretched while being taken up onto a chill roller where it is cooled to produce a cast film.

In an embodiment, the APPCs disclosed herein may produce cast films having a 1% secant modulus of from 50 kpsi to 350 kpsi, alternatively from 100 kpsi to 250 kpsi, alternatively from 100 kpsi to 200 kpsi as determined in accordance with ASTM D882. The secant modulus is a measure of the stress to strain response of a material or the ability to withstand deformation under an applied force and is equated with the film stiffness.

In an embodiment, the APPCs disclosed herein may produce cast films having a tensile strength at yield of from 1,000 psi to 5,000 psi, alternatively from 2,000 psi to 4,000 psi, alternatively from 3,000 psi to 3,500 psi. The tensile strength at yield is the force per unit area required to yield a material, as determined in accordance with ASTM D882. In an embodiment, the APPCs disclosed herein may produce cast films having an elongation at yield of from 3% to 40%, alternatively from 5% to 20%, alternatively from 7% to 10%. The elongation at yield is the percentage increase in length that occurs at the yield point of a material, as determined in accordance with ASTM D882. In an embodiment, the APPCs disclosed herein may produce cast films having a tensile strength at break of from 2,000 psi to 9,000 psi, alternatively from 3,000 psi to 7,000 psi, alternatively from 4,000 psi to 6,000 psi. The tensile strength at break is the force per unit area required to break a material, as determined in accordance with ASTM D882. In an embodiment, the APPCs disclosed herein may produce cast films having an elongation at break of from 50% to 1000%, alternatively from 200% to 900%, alternatively from 400% to 700%. The elongation at break is the percentage increase in length that occurs before a material breaks under tension, as determined in accordance with ASTM D882.

In an embodiment, the APPC disclosed herein may produce cast films having a falling dart impact of from 50 g to 900 g, alternatively from 100 g to 700 g, alternatively from 300 g to 600 g. Falling Dart impact, also known as Gardner impact, is measured using a weighted dart of 1.5 inches in diameter that is dropped from a height of 26 inches onto a flat plaque. The 50% mean failure weight is determined to be the Falling Dart impact, as determined in accordance with ASTM 3029 Method G. The falling dart impact of a cast film produced from an APPC of the type described herein may be increased by from 5% to 40%, alternatively from 10 to 40%, alternatively from 20% to 40% when compared to neat polypropylene with similar melt flow rate.

In an embodiment, the APPC is used to prepare a blown film. In such an embodiment, the extruded APPC may be fed to an annular die having an outer ring and an inner mandrel forming a small gap typically between 1 to 3 millimeters. Additionally, the annular die may comprise two independent air streams, the first of which flows upwardly from the center of the mandrel and the second of which flows generally upward and slightly inward from just beyond the exterior of the outer ring.

As the molten polymer is pushed and pulled upward, the inner air flow is used to provide sufficient air volume to inflate the blown film into a bubble. In some cases in order to maximize throughput, internal bubble cooling (IBC) is employed by circulating chilled air inside the bubble to provide additional cooling. The outer air flow serves to cool the molten polymer and to provide an air curtain which helps to maintain a stable bubble of the desired shape and diameter. In some cases an internal bubble stabilizer (IBS) is used to help control the bubble shape. An IBS can be generally be described as a tube located at the center of the die extending upwards with an inverted cone shape on its end. Since bubble expansion occurs shortly after making contact with the IBS cone, the height of the IBS cone relegates the neck height. Typically, the inner air pressure will be slightly higher than atmospheric air pressure, thus it is possible to maintain a stable film bubble which does not tend to collapse in on itself. The film bubble travels upwardly a distance of 20 to 40 feet and is pinched closed at its upper most end by a pair of nip rollers and is then pulled onto a take up roll. In some embodiments, there may be additional processing steps between the nip rollers and the take up roll such as for example heat welding, perforation, corona treatment, or the like. In other embodiments, the nipped, blown film bubble may be cut or slit along one side and opens the film out into a biaxially-oriented sheet prior to winding on the take up roll.

One polymer film property that may be correlated to the rheological characteristics of the APPC melt is film bubble stability, which is a qualitative property. Without wishing to be limited by theory, increasing the rheological breadth of the polymer may produce more stable blown films bubbles. Rheological breadth refers to the breadth of the transition region between Newtonian and power-law type shear rate or frequency dependence of the viscosity. The rheological breadth is a function of the relaxation time distribution of the resin, which in turn, is a function of the resin molecular structure or architecture. Rheological breadth also governs the shape and stability of the bubble which relates to the processability of the polymer.

Bubble stability is a variable that affects manufacturing efficiency. During the production of blown film, bubbles that tend to breath, dance, or shake will generally result in reduced quality material due to poor gauge distribution. Poor bubble stability is often addressed by reducing the blown film line speed. While operating the blown film line at slower speeds may correct film bubble stability issues, the slower speeds negatively impact manufacturing efficiency. In an embodiment, blown films produced from an APPC of the type described herein may result in an increased bubble stability when compared to blown films produced from neat polypropylene.

The APPCs may also be used to prepare foamed polymeric compositions. For example, the APPC may be mixed, melted, and foamed via extrusion, and the melted and foamed copolymer fed to a shaping process (e.g., mold, die, lay down bar, etc.). The foaming of the APPC may occur prior to, during, or subsequent to the shaping. Alternatively, the molten APPC may also be injected into a mold, where the composition undergoes foaming and fills the mold to form a shaped end-use article.

In an alternative embodiment, the APPC is formed into a sheet, which is then subjected to further processing steps such as thermoforming to produce an end-use article.

The APPC may also be used to prepare oriented polypropylene, alternatively biaxially oriented polypropylene (BOPP). Generally, orientation of a polymer composition refers to the process whereby directionality (the orientation of molecules relative to each other) is imposed upon the polymeric arrangements in the film. Such orientation is employed to impart desirable properties to films, such as toughness and opaqueness, for example. As used herein, the term “biaxial orientation” refers to a process in which a polymeric composition is heated to a temperature at or above its glass-transition temperature but below its crystalline melting point. Immediately following heating, the material may then be extruded into a film, and stretched in both a longitudinal direction (i.e., the machine direction) and in a transverse or lateral direction (i.e., the tenter direction). Such stretching may be carried out simultaneously or sequentially.

The APPC may also be used in extrusion coating applications. Extrusion coating is the coating of a molten resin onto a substrate, i.e., board, paper, aluminum foils, cellulose, or plastic films. The process of extrusion coating involves extruding resin from a slot die at temperatures of up to 320° C. directly onto a moving web which is then passed through a nip. The nip comprises a rubber covered pressure roller and a chrome plated cooling roll that cools the molten film back into a solid state and also imparts a desired finish to the plastic surface. Examples of markets for extrusion coating includes without limitation a variety of end-use applications such as liquid packaging, photographic, flexible packaging, and other commercial applications. Generally, low density polyethylene (LDPE) is used in extrusion coating. Polypropylene typically cannot be extrusion coated at a similar speed as LDPE due to its low melt strengths. The APPC contains branched materials and has higher melt strengths, and thus more suitable for extrusion coating process.

The APPCs of this disclosure may be converted to end-use articles by any suitable method. In an embodiment, this conversion is a plastics shaping process such as known to one of ordinary skill in the art. Examples of end use articles into which the polymeric blend may be formed include food packaging, office supplies, plastic lumber, replacement lumber, patio decking, structural supports, laminate flooring compositions, polymeric foam substrate; decorative surfaces (i.e., crown molding, etc.) weatherable outdoor materials, point-of-purchase signs and displays, house wares and consumer goods, building insulation, cosmetics packaging, outdoor replacement materials, lids and containers (i.e., for deli, fruit, candies and cookies), appliances, utensils, electronic parts, automotive parts, enclosures, protective head gear, reusable paintballs, toys (e.g., LEGO bricks), musical instruments, golf club heads, piping, business machines and telephone components, shower heads, door handles, faucet handles, wheel covers, automotive front grilles, and so forth. Additional end use articles would be apparent to those skilled in the art.

### EXAMPLES

The disclosure having been generally described, the following examples are given as particular embodiments of the disclosure and to demonstrate the practice and advantages thereof. It is understood that the examples are given by way of illustration and are not intended to limit the specification or the claims to follow in any manner.

### Example 1

The effect of varying the acrylate monomer type on the final properties of the APPCs was investigated. Three APPC samples, designated Samples 1-3, were prepared from PP resins, acrylate monomers, and initiators. Each sample contained the PP resin EOD 02-15, which is a metallocene ethylene propylene random copolymer with a MFR of 11 g/10 min. The acrylate monomers were CD560 alkoxylated hexanediol diacrylate, which is a hydrophilic diacrylate; SR351 trimethylolpropane triacrylate (TMPTA) esters, which is a hydrophilic triacrylate; SR454 ethoxylated trimethylolpropane triacrylate, which is a relatively hydrophobic triacrylate; all of which are commercially available from Sartomer. The initiator used was TRIGANOX 301, which is 3,6,9-triethyl-3,6,9-trimethyl-1,4,7-triperoxonane; commercially available from Arkema. 200 ppm t-butyl catechol (TBC) was used as an inhibitor to adjust free radical polymerization during liquid injection to the extruder for reactive extrusion. Formulations for Samples 1-3 are set forth in Table 4. The weight percentages of PP and acrylate are based on the total weight. The weight percentage and ppm of Trigonox 301 and TBC are based on the weight of liquid acrylate monomer only.

TABLE 4

| | | | | | | TRIGONOX |
|---|---|---|---|---|---|---|
| | PP | | Acrylate | | TBC | 301 |
| Sample | Resin | wt. % | Monomer | wt. % | ppm | wt. % |
| 1 | EOD 02-15 | 95 | CD560 | 5 | 200 | 0.5 |
| 2 | EOD 02-15 | 95 | SR351 | 5 | 200 | 0.5 |
| 3 | EOD 02-15 | 95 | SR454 | 5 | 200 | 0.5 |

Each sample was prepared by mixing the components according to the formulations in Table 4. Next, the sample was fed into a MICRO-27 Leistritz twin-screw extruder at a screw speed of 250 rpm with vacuum devolatilization enabled and a throughput rate of 20 lbs/hr. The zone profiles were 320° F.-320° F.-325° F.-330° F.-335° F.-340° F.-340° F.-340° F.-340° F. The experimental processing parameters are summarized in Table 5.

TABLE 5
Process Variables

| | |
|---|---|
| Temperature | 320-320-325-330-335-340-340-340-340-340-340-340° F. |
| Setting | |
| Pre-mix | Acrylate Monomer + TRIGONOX 301 + TBC premixed |
| Total | 20 lbs/hr |
| throughput | |
| Rate | |
| Screw Speed | 250 rpm |
| Vacuum Devol | on |

The melt pressure, torque, and specific energy are tabulated in Table 6. The MFRs of the neat base PP resins (feedstock) and sample (REX resin) are also tabulated in Table 6.

TABLE 6

| | Sample 1 | Sample 2 | Samples 3 |
|---|---|---|---|
| Acrylate Monomer | CD560 | SR351 | SR454 |

Processing Conditions

| | | | |
|---|---|---|---|
| Melt Pressure (psi) | 670 | 650-910 | 720 |
| Torque (%) | 56 | 61 | 66 |
| Specific Energy (kw/lb/hr) | 15.2 | 16.6 | 17.9 |

Melt Flow Rates

| | | | |
|---|---|---|---|
| Feedstock MFR (g/10 min) | 12 | 12 | 12 |
| REX resin MFR (g/10 min) | 9.5 | 5.1 | 8.4 |

During reactive extrusion process, the melt pressure for the sample containing the hydrophilic triacrylate SR351, Sample 2, experienced a melt pressure surge in the late stage of reactive extrusion process while the other two samples (Samples 1 and 3) had a relatively steady melt pressure i.e., no melt pressure surge was observed. Higher torques and specific energies were observed for the samples comprising triacrylate monomer (Samples 2 and 3) compared to the sample comprising diacrylate monomer, Sample 1. Lower MFR values were also observed for Samples 2 and 3 compared to Sample 1. However, the sample comprising hydrophobic triacrylate (Sample 2) was able to decrease the MFR to a greater extent than the sample containing the hydrophilic triacrylate monomer (Sample 3).

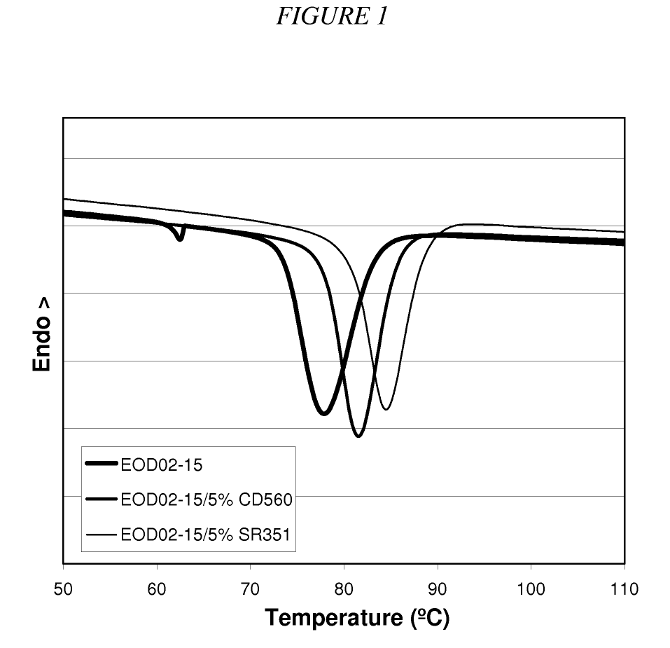

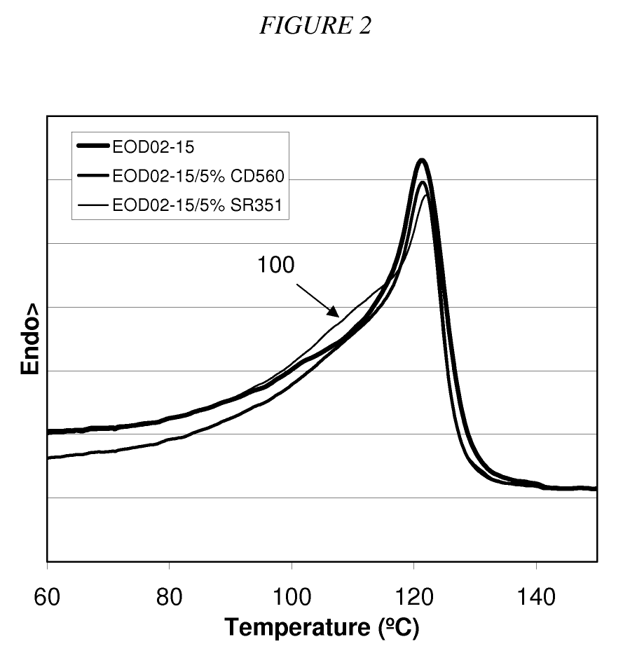

The samples were further characterized by Differential Scanning Calorimetry (DSC). FIGS. 1 and 2 respectively show the DSC re-crystallization and melting curves of neat EOD 02-15 (as a control sample), Sample 1, and Sample 2. FIG. 1 is a plot of DSC crystallization of the materials during cooling process; and FIG. 2 is a plot of DSC melting of the materials during heating process. Referring to FIG. 1, Samples 1 and 2 exhibited a higher re-crystallization temperature suggesting the acrylate monomer has a nucleating effect. However, referring to FIG. 2, the melting behavior of the control sample, Sample 1, and Sample 2 were similar. Again referring to FIG. 2, Sample 2 also displayed a low temperature shoulder 100, indicating a potentially low heat seal initiation temperature (SIT) which may be useful for improving the heat seal properties of the APPC.

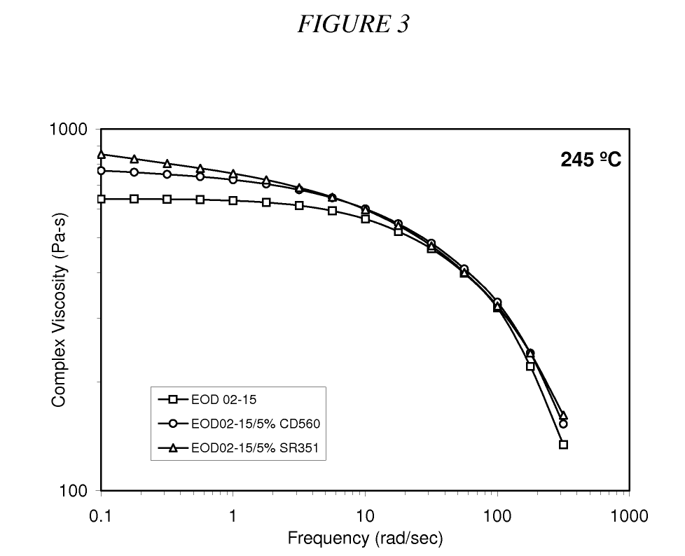

The dynamic rheology of the control sample, Sample 1, and Sample 2 was also investigated. FIG. 3 is a plot of complex viscosity as a function of frequency for each of the samples. Complex viscosity is a frequency-dependent viscosity function determined during forced harmonic oscillation of shear stress, which is related to the complex shear modulus and represents the angle between the viscous stress and the shear stress. Generally, branching affects the complex viscosity, i.e., long chain branching tends to increase the low shear or zero shear viscosity (ZSV) and may be accompanied by more shear thinning. The shear response curves of Samples 1 and 2 in FIG. 3 shows increased in the ZSV and the overall shear-thinning properties were minimally affected.

### Example 2

The effect of the type of polypropylene used on the final characteristics of the APPCs was investigated. Four APPC samples, designated Samples 4-7, were prepared from PP resins, acrylate monomers, and initiators. The PP resins were M6823MZ, which was a 30 dg/min melt flow rate metallocene catalyzed random copolymer; 6823MZ, which was a 32 dg/min melt flow rate Ziegler-Natta catalyzed random copolymer; M3661, which was a 14 dg/min melt flow rate metallocene-catalyzed polypropylene homopolymer; and 3761, which is a 18 dg/min melt flow rate polypropylene homopolymer; all of which are commercially available from Total Petrochemicals USA, Inc. Formulations for Samples 4-7 are set forth in Table 7 as weight percentages. The weight percentages of PP and acrylate are based on the total weight. The weight percentage and ppm of Trigonox 301 and TBC are based on the weight of liquid acrylate monomer only.

TABLE 7

| | | | | | | TRIGONOX |
|---|---|---|---|---|---|---|
| | PP | | Acrylate | | TBC | 301 |
| Sample | Resin | wt. % | Monomer | wt. % | ppm | wt. % |
| 4 | M6823MZ | 95 | SR351 | 5 | 200 | 0.5 |
| 5 | 6823MZ | 95 | SR351 | 5 | 200 | 0.5 |
| 6 | M3661 | 95 | SR351 | 5 | 200 | 0.5 |
| 7 | 3761 | 95 | SR351 | 5 | 200 | 0.5 |

The sample was reactive extruded using processing parameters described in Example 1. The melt pressure, torque, specific energy, and MFRs of PP resins (feedstock) and sample (REX resin) were recorded and are tabulated in Table 8.

TABLE 8

| | | | | Sample |
|---|---|---|---|---|
| | Sample 4 | Sample 5 | Sample 6 | 7 |
| PP Resin | M6823MZ | 6823MZ | M3661 | 3761 |

Processing Conditions

| | | | | |
|---|---|---|---|---|
| Melt Pressure (psi) | 390 | 270 | 520-750 | 380-480 |
| Torque (%) | 50 | 46 | 64 | 58 |
| Specific Energy (kw/lb/hr) | 13.4 | 11.7 | 16.4 | 15.7 |

Melt Flow Rates

| | | | | |
|---|---|---|---|---|
| Feedstock MFR (g/10 min) | 30 | 37.7 | 13.3 | 22.3 |
| REX resin MFR (g/10 min) | 9.4 | 7.5 | 4.1 | 3.9 |
| MFR ratio Feedstock/REX | 3.2 | 5.0 | 3.2 | 5.7 |

Overall, the MFRs for the reaction extruded (REX) samples decreased with the addition of the acrylate monomer. The effect of the addition of the acrylate monomer on the MFR was more pronounced for the Ziegler-Natta catalyzed resins (Samples 5 and 7) whose MFR decreased further than the MFR of metallocene catalyzed resins (Samples 4 and 6) under similar reactive extrusion conditions. Without wishing to be limited by theory, the difference in the effect of the acrylate monomers on the MFR of Ziegler-Natta catalyzed resins may be attributed to the presence in these resins of an increased number of high molecular weight species having a broader molecular weight distribution when compared to metallocene catalyzed resins.

### Example 3

Samples 1, 2, 6, and 7 were used to prepare cast films and various properties of the film were investigated. The films were prepared by using 10″ wide coat-hanger type slit die and a 1.25″ single screw extruder. The die gap was set to 20 mils and the extruder screw speed and the take-off speed were adjusted to produce 2 mils thick cast films.

Cast films produced from Samples 1 and 2 which comprised metallocene based polypropylene random copolymer resins displayed good clarity and relatively low gels. However, when homopolymer polypropylene was used as the base resin (Samples 6 and 7), the extruded melts appeared to be elastic, which resulted in a reduced film quality. Without wishing to be limited by theory, the cast film produced using polypropylene homopolymers may display reduced film quality when compared to cast film prepared using an APPC of the type described herein due to the presence of an increased number of higher molecular weight components (e.g., long-chain molecules, branched, crosslinked) in the polypropylene homopolymer.

### Example 4

APPC samples were evaluated for blown film applications. Nine samples, designated Samples 8-16, were prepared. The samples were prepared from PP resins 4170, 4280, and 4380, acrylate monomer SR259, and CN2404 commercially available from Sartomer. PP resins 4170, 4280, and 4380 are low MFR impact polypropylene copolymers commercially available from Total Petrochemicals USA, Inc; SR259 is polyethylene glycol (200) diacrylate and CN2404 is a viscous metallic monomer, both of which are commercially available from Sartomer. The initiator used was TRIGONOX 301 as described in Example 1. Formulations for Samples 8-16 are set forth in Table 9 as weight percentages. The weight percentages of PP and acrylate are based on the total weight. The weight percentage and ppm of Trigonox 301 and TAC are based on the weight of liquid acrylate monomer only.

TABLE 9

| | | | | | | TRIGONOX | |
|---|---|---|---|---|---|---|---|
| | PP | | Acrylate | | TAC | 301 | |
| Sample | Resin | wt. % | Resin | wt. % | ppm | wt. % | MFR |
| 8 | 4170 | 100 | n/a | n/a | n/a | n/a | 0.76 |
| 9 | 4280 | 100 | n/a | n/a | n/a | n/a | 1.3 |
| 10 | 4380 | 100 | n/a | n/a | n/a | n/a | 3.5 |
| 11 | 4176 | 95 | CD560 | 5 | 200 | 0.5 | 0.5 |
| 12 | 4380 | 95 | CD560 | 5 | 200 | 0.5 | 1.9 |
| 13 | 4380 | 95 | SR259 | 5 | 200 | 0.5 | 1.29 |
| 14 | 4280 | 95 | CD560 + CN2404 | 2.5% + 2.5% | n/a | 0.5 | 0.6 |
| 15 | 4380 | 95 | CD560 + CN2404 | 2.5% + 2.5% | n/a | 0.5 | 2.3 |
| 16 | 4280 | 95 | CD560 + CN2404 | 2.5% + 2.5% | n/a | 0.5 | 4.1 |

Each sample was prepared by mixing the components according to the formulations in Table 9. Next, the sample was fed into a 2.25″ single-screw extruder with no screen pack at a screw speed of 250 rpm with vacuum devolatilization enabled and a throughput rate of 20 lbs/hr. The zone profiles were 350° F.-350° F.-280° F.-330° F.-340° F.-340° F.-330° F.-330° F.-330° F. The experimental processing parameters are summarized in Table 10.

TABLE 10
Process Variables

| | |
|---|---|
| Temperature | 350-350-280-330-340-340-340-340-340-330-330-330° F. |
| Setting | |
| Pre-mix | Monomer + TRIGONOX 301 + TAC premixed |
| Total | 20 lbs/hr |
| throughput | |
| Rate | |
| Screw Speed | 250 rpm |
| Vacuum Devol | on |

The MFR, melt pressure, and extrusion output for each sample was recorded and are tabulated in Table 11.

TABLE 11

| | | | | Extrusion Output |
|---|---|---|---|---|
| | | | | at 150 rpm |
| | Samples | MFR | Melt Pressure (psi) | (lbs/hr) |
| Plant ICP | 8 | 0.76 | 1056 | 25.66 |
| | 10 | 3.5 | 566 | 26.7 |
| REX ICP | 11 | 0.5 | 752 | 27.8 |
| | 14 | 0.6 | 701 | 27.4 |
| | 12 | 1.9 | 507 | 27.3 |
| | 15 | 2.3 | 493 | 28 |
| | 16 | 4 | 521 | 28.5 |

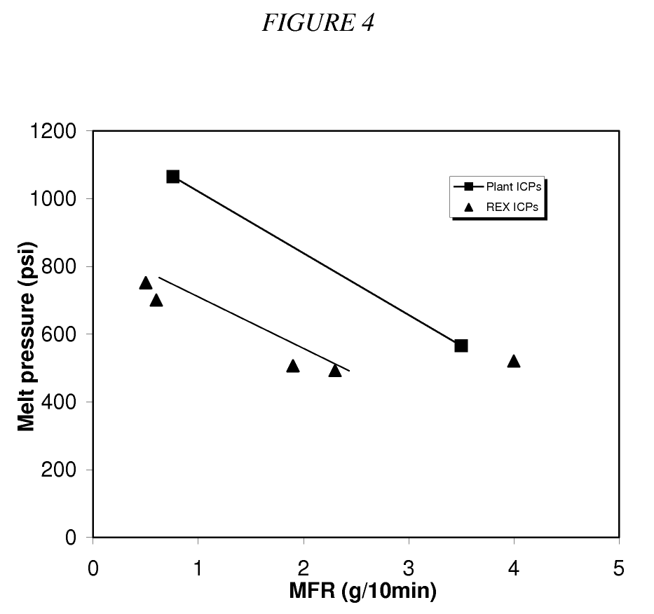

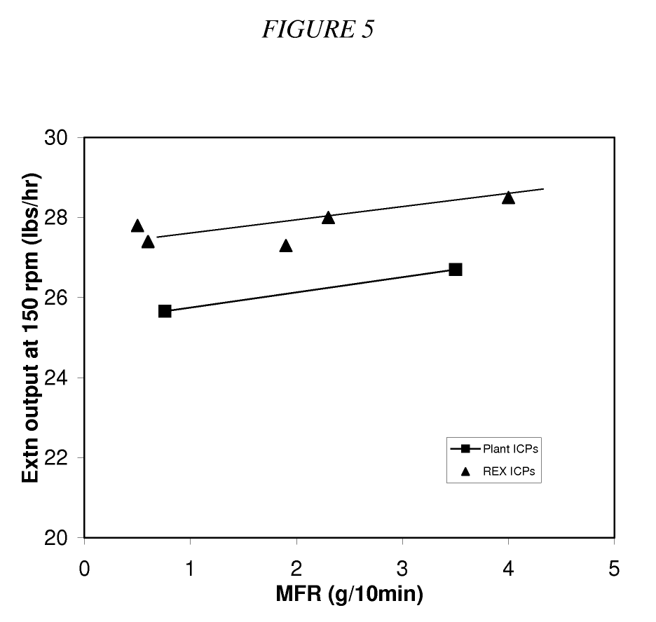

FIGS. 4 and 5 are plots of melt pressure and extrusion output at 150 rpm as a function of MFR respectively. From the results, the APPC materials (Samples 11-16) showed an approximate 25% decrease in the melt pressure and a 8-10% increase in the extrusion output when compared to neat PP (Samples 8-10).

The samples were also evaluated for blown film processing on a small blown film co-extrusion line, which is commercially available from David Standard. The blown-up ratio was and the film gauge was 1 mil. For comparative purposes, the extrusion conditions were adjusted to make destabilize the bubble formed during production of a blown film from Sample 1. Then, without changing processing variables, Samples 2, 3, and some other samples were dropped in respectively. The bubble was still unstable when processing the materials. When Sample 16 was dropped in, the bubble seemed to become more stable.

### Example 5

The properties of cast films produced from APPCs were investigated. Five samples, designated Samples 17-21, were prepared. The PP resin was 4380WZ PP resin, which is a PP impact copolymer with an MFR of 3.5 dg/min. commercially available from Total Petrochemical USA, Inc.; the acrylate monomer was SR259, and the initiator was LUPERSOL 101. An odorless mineral spirit (OMS) (0.5 wt. %) was added to Sample 21. Formulations for Samples 17-21 are set forth in Table 12 as weight percentages. The weight percentages of PP and acrylate are based on the total weight. The weight percentage of LUPERSOL 101 and OMS are based on the weight of liquid acrylate monomer only.

The samples were reactive extruded using a 27 mm twin-screw extruder at a screw speed of 250 rpm, a throughput rate of 20 lbs/hr, and a melt temperature of around 190° C. The PP resin was fed through the main extruder feed. The acrylate monomer was premixed with the initiator and other additives.

The extruded samples were then casted into 2 mil thick films using standard processing conditions. Compared to Sample 18, Samples 19-21 produced less smokes (i.e., volatile components) as visually observed from the slit die during casting. Sample 21 also produced more smokes which indicated that OMS was not completely removed from the vacuum devolatization during reactive extrusion.

Mechanical properties of cast the films produced from Samples 17-21 were determined and the results are tabulated in Table 12.

TABLE 12

| Sample | | | | |
|---|---|---|---|---|
| 17 | 18 | 19 | 20 | 21 |

| | | | | | |
|---|---|---|---|---|---|
| Base Resin | 4380WZ | 4380WZ | 4380EZ | 4380EZ | 4380EZ |
| Monomer SR259, | n/a | 5 | 2 | 2 | 2 |
| wt. % | | | | | |
| LUPERSOL 101 | n/a | 0.1 | 0.1 | 0.5 | 0.5 with |
| in SR259 | | | | | OMS |
| Melt Flow Rate, | 3.9 | 1.5 | 4.1 | 2 | 3.2 |
| dg/min | | | | | |
| 1% Secant | 123 | 127 | 126 | 131 | 145 |
| Modulus, kpsi | | | | | |
| Tensile Strength | 3497 | 3734 | 3692 | 3733 | 4117 |
| at Yield (MD), | | | | | |
| psi | | | | | |
| Tensile Strength | 5259 | 5564 | 4863 | 5614 | 5359 |
| at Break (MD), | | | | | |
| psi | | | | | |
| Elongation at | 9.1 | 9.8 | 9.6 | 9.5 | 7.5 |
| Yield (MD), % | | | | | |
| Elongation at | 671 | 702.3 | 630.6 | 728.5 | 706.8 |
| Break (MD), % | | | | | |

| Falling Dart | A - 26″ drop with 1.5″ diameter dart | | | | |
|---|---|---|---|---|---|
| Mean Failure | 346.2 | 400.5 | 418.5 | 480.2 | 252 |
| Weight (g) | | | | | |

Referring to Table 12, Sample 18 prepared using 5 wt. % of acrylate monomer showed improvements in tensile strength, stiffness, and impact resistance when compared to Sample 17 which was prepared in the absence of an acrylate monomer. Samples 20 and 21, prepared using 2 wt. % acrylate monomer showed improved tensile strength with the exception of tensile strength when compared to Sample 17; while Samples 19 and 20 displayed improved impact resistance. High peroxide initiator level also further improved the tensile strength at yield of Sample 21 and further improved the impact resistance of Sample 20.

While various embodiments have been shown and described, modifications thereof can be made by one skilled in the art without departing from the spirit and teachings of the disclosure. The embodiments described herein are exemplary only, and are not intended to be limiting. Many variations and modifications of the subject matter disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference is not an admission that it is prior art to the present invention, especially any reference that may have a publication date after the priority date of this application. The disclosures of all patents, patent applications, and publications cited herein are hereby incorporated by reference, to the extent that they provide exemplary, procedural, or other details supplementary to those set forth herein.

1. A method comprising:
contacting a polypropylene, an acrylate-containing monomer, and an initiator to form a composition; and
reactive extruding the composition to form a polymer blend, wherein the polymer blend comprises from 0.5 wt. % to 4 wt. % acrylate-containing monomer.

2. The method of claim 1 wherein the polymer blend has a melt pressure that is reduced by equal to or greater than 5% when compared to neat polypropylene having a similar melt flow rate.

3. The method of claim 1 wherein the polymer blend has an extrusion rate that is increased by equal to or greater than 5% when compared to neat polypropylene having a similar melt flow rate.

4. The method of claim 1 wherein the acrylate-containing monomer comprises a multi-functional acrylate monomer.

5. The method of claim 4 wherein the multi-functional acrylate monomer comprises a diacrylate monomer, a triacrylate monomer, a tetraacrylate monomer, a pentaacrylate monomer, or combinations thereof.

6. The method of claim 1 wherein the polypropylene comprises a polypropylene homopolymer, a polypropylene impact copolymer, a polypropylene random copolymer, or combinations thereof.

7. The method of claim 1 wherein the polypropylene comprises atactic polypropylene, isotactic polypropylene, hemi-isotactic polypropylene, syndiotactic polypropylene, or combinations thereof.

8. The method of claim 1 wherein the polypropylene is prepared using a Ziegler Natta catalyst, a metallocene catalyst, or combinations thereof.

9. The method of claim 1 wherein the initiator comprises an organic peroxide, benzoyl peroxide, lauroyl peroxide, t-butyl peroxybenzoate, 1,1-di-t-butylperoxy-2,4-di-t-butylcyclohexane, diacyl peroxides, peroxydicarbonates, monoperoxycarbonates, peroxyketals, peroxyesters, dialkyl peroxides, hydroperoxides, t-butyl catechol, 2,5-dimethyl-2,5-di-(tert-butylperoxy) hexane, 3,6,9-triethyl-3,6,9-trimethyl-1,4,7-triperoxonane, or combinations thereof.

10. The method of claim 1 wherein:
the polypropylene is present in the composition in an amount of from 85 wt. % to 99.9 wt. % and
the initiator is present in the composition in an amount of from 0.002 wt. % to 0.5 wt. % wherein the wt. % is based on the total weight of the composition.

11. The method of claim 1 further comprising contacting the composition with one or more additives.

12. The method of claim 11 wherein the additive comprises stabilizers, ultra-violet screening agents, oxidants, anti-oxidants, odorless mineral spirits, anti-static agents, ultraviolet light absorbents, fire retardants, processing oils, mold release agents, coloring agents, pigments, dyes, fillers, blowing agents, fluorescing agent, surfactant, tackifiers, processing oils, or combinations thereof.

13-14. (canceled)

15. A method comprising:
contacting a polypropylene, a multi-functional acrylate monomer, and an initiator to form a composition;
reactive extruding the composition to form a reactive extruded composition comprising from 0.5 wt. % to 4 wt. % multi-functional acrylate monomer; and
forming the reactive extruded composition into a film wherein the reactive extruded composition has a melt flow rate that is reduced by equal to or greater than 5% when compared to neat polypropylene.

16. The method of claim 15 further comprising uniaxially or biaxially orientating the film.

17. The method of claim 15 wherein the film comprises a cast film or a blown film.

18. The method of claim 17 wherein the cast film has a 1% secant modulus of from 50 kpsi to 350 kpsi.

19. The method of claim 17 wherein the cast film has a tensile strength at yield of from 1,000 psi to 5,000 psi.

20. The method of claim 17 wherein the cast film has an elongation at yield of from 3% to 40%.

21. The method of claim 17 wherein the cast film has a tensile strength at break of from 2,000 psi to 9,000 psi.

22. The method of claim 17 wherein the cast film has an elongation at break of from 50% to 1,000% psi.

23. The method of claim 17 wherein the cast film has a falling dart impact of from 50 g to 900 g.

24. The method of claim 17 wherein the blown film has an increased bubble stability when compared to blown films produced from neat polypropylene.

25. The method of claim 17, wherein the cast film has a falling dart impact that is greater than a falling dart impact of a cast film formed from an identical process wherein the reactive extruded composition comprises 5 wt. % multi-functional acrylate monomer.

26. The method of claim 1, wherein the polymer blend comprises from 0.5 wt. % to 3 wt. % acrylate-containing compound.
